(19) United States
(12) Patent Application Publication
(10) Pub. No.: US 2022/0164904 A1
(43) Pub. Date: May 26, 2022

(54) INFORMATION PROCESSING METHOD, INFORMATION PROCESSING DEVICE AND NON-TRANSITORY STORAGE MEDIUM

(71) Applicant: TOYOTA JIDOSHA KABUSHIKI KAISHA, Toyota-shi (JP)

(72) Inventors: Jun USAMI, Toyota-shi (JP); Takaharu UENO, Nagoya-shi (JP); Shunsuke SAGARA, Nisshin-shi (JP); Lei WANG, Toyota-shi (JP); Shintaro MATSUTANI, Kariya-shi (JP); Kyoji IIJIMA, Toyota-shi (JP)

(73) Assignee: TOYOTA JIDOSHA KABUSHIKI KAISHA, Toyota-shi (JP)

(21) Appl. No.: 17/523,164

(22) Filed: Nov. 10, 2021

(30) Foreign Application Priority Data
Nov. 20, 2020 (JP) 2020-193540

(51) Int. Cl. G06Q 50/12; G06Q 30/02; G06Q 30/06

(52) U.S. Cl. CPC G06Q 50/12; G06Q 30/0633; G06Q 30/0254

(57) ABSTRACT

A controller of an information processing apparatus including a controller configured to detect information to indicate a start of use of digital content by a user; acquire information to indicate a period of use of the digital content; and determine a necessity of providing food and beverages to the user based on the information to indicate a period of use.

### CROSS-REFERENCE TO RELATED APPLICATION

This application claims the benefit of Japanese Patent Application No. 2020-193540, filed on Nov. 20, 2020, which is hereby incorporated by reference herein in its entirety.

### BACKGROUND

### 1. Technical Field

The present disclosure relates to an information processing method, an information processing apparatus, and a non-transitory storage medium.

### 2. Description of the Related Art

There is an image processing method that predicts at least one of: the product that a user intends to purchase, the purpose of use, and the date of use, based on schedule information (for example, WO 2020/021813).

### SUMMARY

It is an object of the present disclosure to provide an information processing method, an information processing apparatus and a non-transitory storage medium that may improve convenience of the user in services that provide food and beverages.

One aspect of the present disclosure is an information processing method for an information processing apparatus, the method including: detecting information to indicate a start of use of digital content by a user; acquiring information to indicate a period of use of the digital content; and determining the necessity of providing food and beverages to the user based on the information to indicate the period of use.

Aspects of the present disclosure may include at least one of: an information processing apparatus, an information processing system, a program, and a non-transitory storage medium recording the program, which have the same features as the information processing method.

According to the present disclosure, convenience of the user may be improved in services that provide food and beverages.

### BRIEF DESCRIPTION OF THE DRAWINGS

FIG. 1 is a diagram depicting an example of an information processing system according to an embodiment;

FIG. 2 is a block diagram depicting a configuration example of an information processing apparatus according to an embodiment;

FIG. 3 is a flow chart depicting a processing example in the information processing apparatus;

FIG. 4 is a flow chart depicting a processing example in the information processing apparatus; and

FIG. 5 is a flow chart depicting a processing example in the information processing apparatus.

### DESCRIPTION OF THE EMBODIMENTS

In an information processing method according to an embodiment, the information processing apparatus executes: detecting information to indicate a start of use of digital content by a user; acquiring information to indicate a period of user of the digital content; and determining the necessity of providing food and beverages to the user based on the information to indicate the period of use.

According to the information processing method, when the user uses the digital content, the necessity of providing food and beverages to the user is determined based on the period of use. Thereby the necessity of providing food and beverages to the user is automatically determined without concern for the user currently using the digital content. As a result, convenience of the user may be improved in services that provide food and beverages.

In the information processing method according to the present disclosure, in a case where it is determined that providing food and beverages to the user is necessary, the information processing apparatus may notify the user information to indicate food and beverages that is enable to ordered. Thereby the user currently using the digital content need not check what food and beverages may be ordered, or find out where to place the order. In a case where information to enable the order is received from the user as a response to the above notification, the information processing apparatus may place an order for the food and beverages requested by the user. Then the user currently using the digital content may receive the requested food and beverages merely by choosing desired food and beverages from the available food and beverages that may be ordered.

In the information processing method according to the present disclosure, in the case where it is determined that providing food and beverages to the user is necessary, the information processing apparatus may order a predetermined food and beverage. Thereby the user currently using the digital content may automatically receive the food and beverages without concern of following a procedure to order the food and beverages.

The above mentioned “predetermined food and beverages” may be determined based on the current time. For example, if the current time is immediately after such a meal time as lunch time, the information processing apparatus may determine only beverages, a beverages and dessert, fruit, or the like for the “predetermined food and beverages”. If the current time is in a time period immediately before meal time, the information processing apparatus may determine the food and beverages appropriate for a meal for the “predetermined food and beverages”. If the current time is not immediately before or immediately after meal time, the information processing apparatus may determine snacks or beverages for the “predetermined food and beverages”. Thereby the user currently using the digital content need not check the kind of food and beverages appropriate for the current time, or to find out where to place the order.

The “use of digital content” includes viewing video by video-on-demand (VOD), for example. Videos include movies, concerts, live performances, sports, races, and the like. The “use of digital content” also includes viewing TV broadcast programs (TV programs), listening to music content (e.g. albums), and playing video games. Further, the “use of digital content” includes browsing (reading) websites, reading e-books, and the like. The types of digital content and modes of use thereof are not limited to the above examples.

The “information to indicate a start of use of digital content” is information to indicate input of a start of viewing and listening (e.g. pressing a playback (start) button, a download button of a video or music file, or the like). The “information to indicate a start of use of digital content” is also information to indicate turning the power of a video game machine ON, input to start playing a video game, start a web browser or input an instruction to start a web browser, start an application to view a video or an e-book, or input an instruction to start an application, and the like. The “information to indicate a start of use” is not limited to the above examples.

The “information to indicates a period of use of digital content” includes: a reproduction time of a video or music, a broadcasting time of a TV program, a play time of a game, a browsing time, and the like. Each of the play time of a game and a browsing time may be a time specified by the user, or a time calculated based on past behavior (history) of the user.

In “determining the necessity of providing food and beverages”, it may be determined that providing food and beverages is necessary in a case where the period of use of the digital content is longer than a threshold and the current time is outside a predetermined time zone. The predetermined time is a late night time zone (e.g. 22:00 to 2:59), an early morning time period (e.g. 3:00 to 6:59), or the like. The length of the time period, the start time and the end time may be arbitrarily set.

“Food and beverages” are at least one of food and beverages. The types of food and beverages are not limited, but are preferably those that may be acquired by delivery based on a placed order. The food and beverages may be what the user may partially prepare instead of ready to consume food and beverages.

An information processing method, an information processing apparatus and a non-transitory storage medium storing the program according to an embodiment will be described with reference to the drawings. The configuration described in the embodiment is an example, and the present disclosure is not limited to the configuration described in the embodiment.

<Configuration of the Information System>

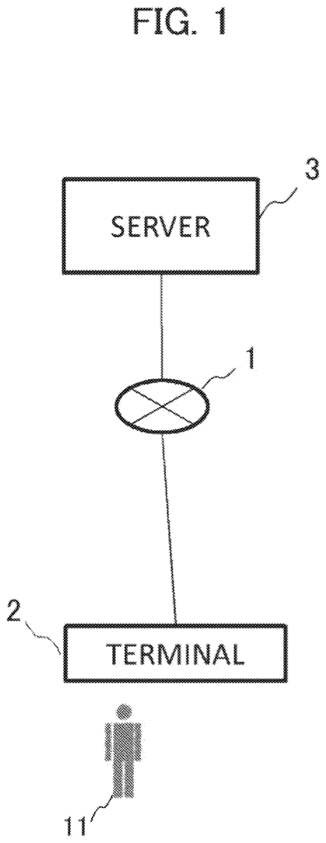

FIG. 1 is a schematic diagram depicting the information processing system according to an embodiment. In FIG. 1, the information processing system includes a terminal 2 and a server 3 which are connected to a network 1. The terminal 2 is used by a user 11. The terminal 2 is an example of an “information processing apparatus” and a “computer” respectively.

The network 1 is such a public communication network as the Internet, for example, for which a wide area network (WAN) or other communication networks may be used. The network 1 may include a wireless network (wireless paths). The wireless network may include a cellular network (e.g. long term evolution (LTE), 5G), wireless local rea network (LAN: including Wi-Fi), BLE, and the like.

The server 3 is a server that provides (distributes) digital content to the user. The server 3 may supply various data in response to a request from the terminal 2. The data is, for example, data on videos (streaming or downloaded), data on online video games (online games), data on websites (e.g. HTML files), or the like.

The terminal 2 is a terminal of the user 11 who uses the digital content. The terminal 2 includes a TV receiver, a personal computer (PC), a workstation (WS), a smart apparatus (including a smartphone and a tablet terminal), a video game machine, an e-book terminal, and the like, which have a function to connect to the Internet. The types of terminal 2 are not limited to these examples.

<Configuration of Terminal>

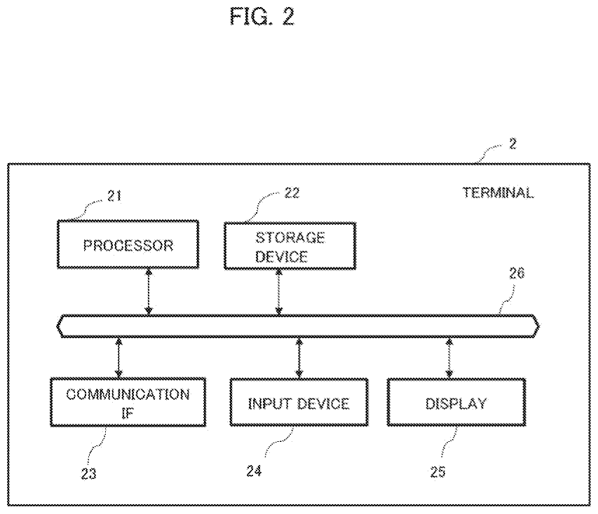

FIG. 2 indicates an example of a configuration of the terminal 2. The terminal 2 has a communication function and may be connected to the network 1 via cable or wirelessly. The terminal 2 includes a processor 21 which is a processing unit or a control unit (controller), a storage device (memory) 22, a communication interface 23 (communication IF 23), an input device 24 and a display 25 which are interconnected via a bus 26.

The storage device 22 is an example of a non-transitory storage medium, and includes a main storage device and an auxiliary storage device. The main storage device is used as a storage area for programs and data, a developing area for programs, a work area for programs, a buffer area for communication data, and the like. The main storage device is constituted of a random access memory (RAM) or a combination of a RAM and a read only memory (ROM). The auxiliary storage device is used as a storage area for programs and data. For the auxiliary storage device, a non-volatile storage medium, such as a hard disk, a solid-state drive (SSD), a flash memory, and an electrically erasable programmable read only memory (EEPROM) may be used. The storage device 22 may include a drive device for a disk storage medium.

The communication IF 23 is a circuit to perform communication processing. For example, the communication IF 23 is a network interface card (NIC). The communication IF 23 may be a wireless communication circuit to perform wireless communication (e.g. LTE, 5G, wireless LAN (Wi-Fi), BLE). Further, the communication IF 23 may be a combination of a circuit to perform communication processing via a cable or a wireless communication circuit.

The input device 24 includes at least one of: keys, buttons, pointing device, touch panel, and the like; and is used to input information. The display 25 is a liquid crystal display or the like, for example, and displays information and data.

The processor 21 is a central processing unit (CPU) (also called a microprocessor unit (MPU)), for example. The processor 21 may have a single processor configuration or a multi-processor configuration. A single physical CPU connected via a single socket may have a multi-core configuration. The processor 21 may include arithmetic devices having various circuit configurations, such as a digital signal processor (DSP), or a graphics processing unit (GPU). Further, the processor 21 may have a configuration that links at least to one of an integrated circuit (IC), other digital circuits, and analog circuits. The integrated circuit includes an LSI, an application specific integrated circuit (ASIC), a programmable logic device (PLD), and the like. The PLD includes a field programmable gate array (FPGA), for example. The processor 21 includes a micro-controller (MCU), a system-on-a-chip (SoC), a system LSI, a chip set, and the like.

The processor 21 performs various processing by executing various programs stored in the storage device 22.

### Operation Example 1

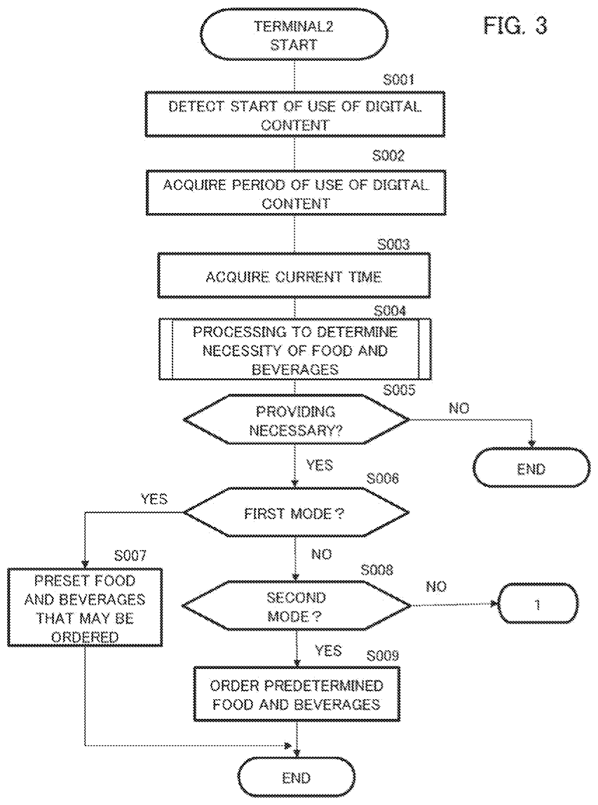

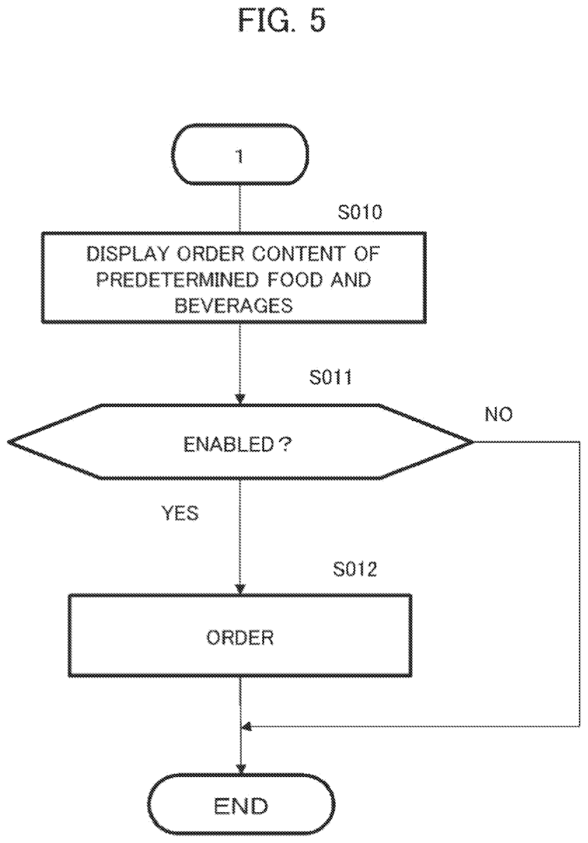

FIG. 3 to FIG. 5 are flow charts indicating examples of the processing executed by the processor 21 of the terminal 2. In Operation Example 1, a case where the user 11 views a video by downloading the content from the server 3 using the terminal 2 will be described.

In step S001, the processor 21 detects information to indicate a start of use of the digital content. In a case of viewing a video using the terminal 2 by downloading the video from the server 3, the user 11 presses a download button of the target video to view using the input device 24. The processor 21 detects the information or the signals generated by the operation of downloading the video as the information to indicate a start of use of the digital content, that is, as information to indicate an operation to start viewing the video. The information to indicate a start of use may be information (signals) to indicate an operation to start reproduction of the downloaded video file.

In step S002, the processor 21 acquires information to indicate a period of use of the digital content. For example, as the information to indicate a period of use of digital content, the processor 21 acquires the information to indicate the reproduction time of a video included in the information to indicate the content of the target video to be downloaded, which is stored in the storage device 22.

In step S003, the processor 21 acquires the current time. The current time may be acquired from an internal clock using a crystal oscillator included in the CPU as the processor 21, for example.

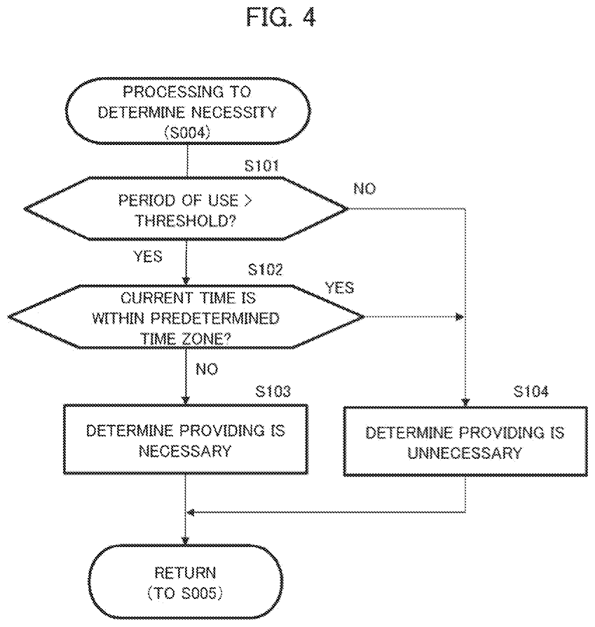

In step S004, the processor 21 performs the processing to determine the necessity of food and beverages. FIG. 4 is a flow chart depicting an example of the processing to determine the necessity of food and beverages. In step S101, the processor 21 determines whether the reproduction time (or information other than the reproduction time) of the video, which is used as the information to indicate a period of use, exceeds a threshold stored in the storage device 22. The threshold is a value to be an index to determine whether the food and beverages may be provided within the period of use of the digital content (within the reproduction time of the video). The threshold is determined by considering the time required for preparing the food and beverages, the time required for delivery of the food and beverages, and the like, for example. The time required for preparation of the food and beverages may be determined based on an average preparation time or the longest preparation time required for the provider of the food and beverages delivery service, for example. The time required for delivery of the food and beverages may be determined based on an average delivery time or on the longest delivery time required for the provider of the food and beverages delivery service. Processing advances to step S102 if it is determined that the period of use exceeds the threshold (YES in S101), or processing advances to step S104 if not (NO in S101). The determination in step S101 may be a determination whether the period of use is at least the threshold or not.

In step S102, the processor 21 determines whether the current time is within a predetermined time zone that is stored in the storage device 22 in advance. The information to indicate a predetermined time zone is stored in the storage device 22 in advance. For example, the predetermined time zone is a late night to early morning time zone (22:00 to 3:00 next day), and is a time zone in which the user 11 normally does not consume food and beverages very much, or is a time zone in which food and beverages normally are not delivered very much. However, the length, the start time and the end time of a predetermined time zone may be set arbitrarily.

Processing advances to step S104 if it is determined that the current time is within the predetermined time zone in step S102 (YES in S102), or processing advances to step S103 if not (NO in S102).

In the case where the processing advanced to step S103, the processor 21 determines that providing food and beverages is necessary, and advances the processing to step S005 (FIG. 3). In the case where the processing advances to step S104, the processor 21 determines that providing food and beverages is unnecessary, and advances the processing to step S005 (FIG. 3). The sequence of step S101 and step S102 may be reversed.

In step S005, the processor 21 determines whether providing food and beverages is necessary. The processing in FIG. 3 ends if it is determined that providing food and beverages is unnecessary (NO in S005). If it is determined that providing food and beverages is necessary (YES in S005), on the other hand, processing advances to step S006. Steps S103, S104 and S005 may be omitted, and the processing in FIG. 3 may end in the case where the determination in step S102 is YES, and the processing may advance to step S006 in the case where the determination in step S102 is NO.

In step S006, the processor 21 determines whether the current operation mode is a first mode. Here a first mode, a second mode and a third mode are provided as operation modes in cases where it is determined that providing food and beverages is necessary. Currently information, to indicate which one of the first mode to the third mode is selected (mode information), is stored in the storage device 22. The processor 21 determines whether the current mode is set to the first mode with reference to the mode information. Processing advances to step S007 if it is determined that the current mode is the first mode (YES in S006), or processing advances to S008 if not (NO in S006).

In the case where the processing advanced to step S007, the processor 21 performs operation in accordance with the first mode. In other words, the processor 21 notifies the user 11 information to indicate the food and beverages that may be ordered, as the operation in accordance with the first mode. This means that the processor 21 displays (presents) a menu screen, that indicates the food and beverages that may be ordered, on the display 25.

The user 11 may order a desired food and beverages using the menu screen and the input device 24. For example, when the user 11 selects a desired food and beverages from the menu and presses the order button, the order information is sent over the network via the communication IF 23 to the store to which the order is placed. The order information includes a name of the user 11, an address of the delivery destination, a contact phone number, and information to indicate the ordered food and beverages.

The store prepares the ordered food and beverages and delivers the food and beverages to the delivery destination specified by the user 11. Thereby the user 11 may receive a desired food and beverages without checking the food and beverages that may be ordered, or checking where to place the order. The user 11 may call the store using the telephone number indicated on the menu screen.

In step S008, the processor 21 determines whether the current operation mode is the second mode. In other words, the processor 21 determines whether the current mode is set to the second mode with reference to the mode information stored in the storage device 22. Processing advances to S009 if it is determined that the current mode is the second mode (YES in S008), or processing advances to S010 if not (NO in S008).

In step S009, the processor 21 performs processing to order a predetermined food and beverages. In other words, the processor 21 sends the order information on the preset food and beverages over the network 1. In the second mode, the order information on the preset food and beverages is sent regardless the intent of the user 11. The preset food and beverages (predetermined food and beverages) may be determined based on the current time. For example, if the current time is immediately after the meal time zone, such as a lunch time zone, only beverages or only desserts or fruits may be determined as the predetermined food and beverages. If the current time is immediately before the meal time zone, food and beverages appropriate for meals may be determined as the predetermined food and beverages. Further, if the current time is not immediately before or after the meal time zone, snacks or beverages may be determined as the predetermined food and beverages. Thereby the user currently watching a video may receive the food and beverages that is appropriate for the current time, without checking the kind of food and beverages appropriate for the current time, or checking where to place the order. The food and beverages displayed on the menu screen in step S007 may also be determined based on the current time.

In step S010, the processor 21 displays the food and beverages that may be ordered, such as the order content of the predetermined food and beverages set in advance, on the display 25, and receives input to enable or disable the order from the user 11.

In step S011, the processor 21 determines whether the user 11 inputted to enable the order. Processing advances to step S012 if it is determined that the input enables the order (YES in S011), or processing ends if not (NO in S011). In step S010, a plurality of types of food and beverages may be displayed (notified), from which the user 11 may select the food and beverages to order using the input device 24. The preset food and beverages (predetermined food and beverages) displayed in step S010 may also be set based on the current time. The food and beverages need not preset all the time, but appropriate food and beverages may be simply recommended.

The video may be reproduced by streaming. In this case, the information to indicate that the reproduction start button is pressed may be used as the information to indicate a start of use of digital content. The video may be a TV program, and the information (signals) to indicate the operation to start viewing the TV program may be used as the information to indicate a start of use of digital content. The broadcasting time of the TV program may be used as the period of use.

### Operation Example 2

In Operation Example 2, a case where the user 11 plays a video game (either an on-line game or off-line game) using the information processing apparatus 10 will be described as an example.

In the case of playing a video game, a title screen of the video game is displayed on the display 25, and the user 11 presses (clicks on) a start button in the title screen using the input device 24.

In step S001, the processor 21 detects information (signals) that is generated by pressing the start button, as the information to indicate the use of digital content, that is, as the information to indicate the operation to start playing the video game.

In the storage device 22, a history of the play time of the video game and an average value of the play time are recorded. In step S002, the processor 21 acquires the average value of the play time from the storage device 22, as the information to indicate a period of use of digital content.

In step S003, the processor 21 acquires the current time. In the processing to determine the necessity of food and beverages in step S004 (FIG. 4), the processor 21 determines whether the play time (information to indicate the period of use) exceeds a threshold stored in the storage device 22 in step S101. Processing advances to step S102 if it is determined that the period of use exceeds the threshold, or processing advances to step S104 if not. The processing steps after step S102 are the same as Operation Example 1, hence description thereof is omitted.

### Operation Example 3

In Operation Example 3, a case where the user 11 performs browsing of websites using the information processing apparatus 10 will be described as an example. The user 11 starts up a web browser (browser) installed in the storage device 22, and displays an initial screen of the browser on the display 25. In step S001, the processor 21 detects information (signals) that is generated by the operation to startup the web browser, as the information to generate the use of digital content, that is, information to indicate the operation to start browsing of websites.

In the storage device 22, a history of browsing and an average value of the browsing time (from startup of the browser to the end time of browsing) are recorded. In step S002, the processor 21 acquires the average value of the browsing time from the storage device 22 as information to indicate a period of use of digital content.

In step S003, the processor 21 acquires the current time. In the processing to determine the necessity of food and beverages (FIG. 4) in step S004, the processor 21 determines whether the browsing time (information to indicate a period of use) exceeds a threshold stored in the storage device 22 in step S101. Processing advances to step S102 if it is determined that the period of use exceeds the threshold, or processing advances to step S104 if not. The processing steps after step S102 are the same as Operation Example 1, hence description thereof is omitted. The information to indicate a type of digital content and the period of use of a digital content is not limited to the above examples described in Operation Examples 1 to 3.

According to the information processing apparatus 10 of the embodiment, when the use of the digital content starts, information to indicate a period of use of a digital content and the current time are acquired. In a case where the period of time is longer than a threshold and the current time is outside a predetermined time zone, it is determined that providing food and beverages is necessary. In this way, when the user 11 starts to use the digital content, the necessity of providing food and beverages may be determined.

According to the information processing apparatus 10, when it is determined that providing food and beverages is necessary, the information processing apparatus 10 performs one of: recommending the food and beverages that may be ordered to the user 11 (first mode); automatically ordering a predetermined food and beverages (second mode); and inquiring if ordering of a predetermined food and beverages is enabled (third mode). Thereby the user 11 may receive food and beverages in accordance with the operation mode desired by the user 11.

<Others>

The embodiments described above are merely examples, and the present disclosure may be changed and modified as required without departing from the spirit and scope thereof.

Processing steps executed by one device in the above description may be shared by a plurality of devices. Further, processing steps executed by different devices in the above description may be executed by one device. In a computer system, the hardware configuration (server configuration) to implement each functions may be flexibly changed.

The present disclosure may be implemented by supplying a computer program, having functions described in the above embodiment, to a computer, with at least one processor of the computer reading and executing the program. The computer program may be accessible by the computer using a non-transitory computer readable storage medium that may be connected to the system bus of the computer, or may be provided to the computer via a network. The non-transitory computer readable storage medium is an arbitrary type of disk, for example, such as a magnetic disk (e.g. floppy (registered trademark) disk, hard disk drive (HDD)), and an optical disk (e.g. CD-ROM, DVD, Blu-ray). The non-transitory computer readable medium includes a read only memory (ROM), a random access memory (RAM), an EPROM, an EEPROM, a magnetic card, a flash memory, an optical card, and an arbitrary type of medium appropriate for storing electronic instructions.

What is claimed is:

1. An information processing method, comprising:
Detecting, by an information processing apparatus, information to indicate a start of use of digital content by a user;
acquiring, by the information processing apparatus, information to indicate a period of use of the digital content; and
determining, by the information processing apparatus, a necessity of providing food and beverages to the user based on the information to indicate a period of use.

2. The information processing method according to claim 1, further comprising notifying, by the information processing apparatus, the information processing apparatus notifies the user information to indicate food and beverages that may be ordered in a case where it is determined that providing food and beverages to the user is necessary.

3. The information processing method according to claim 1, further comprising ordering, by the information processing apparatus, predetermined food and beverages in a case where it is determined that providing food and beverages to the user is necessary.

4. The information processing method according to claim 1, further comprising:
notifying, by the information processing apparatus, information to indicate food and beverages that the user is enable to order in a case where it is determined that providing food and beverages to the user is necessary; and
ordering, by the information processing apparatus, the food and beverages notified to the user in a case where information to enable an order is received from the user.

5. The information processing method according to claim 3, further comprising determining, by the information processing apparatus, the predetermined food and beverages based on the current time in a case where it is determined that providing food and beverages to the user is necessary.

6. The information processing method according to claim 1, further comprising:
detecting, by the information processing apparatus, information to indicate an operation to start viewing a video, as the information to indicate a start of use of digital content; and
acquiring, by the information processing apparatus, information to indicate reproduction time of the video, as the information to indicate a period of use of digital content.

7. The information processing method according to claim 1, further comprising:
detecting, by the information processing apparatus, information to indicate an operation to start play of a video game, as the information to indicate a start of use of digital content; and
acquiring, by the information processing apparatus, information to indicate a play time of the video game of the user, as the information to indicate a period of use of digital content.

8. The information processing method according to claim 1, further comprising:
detecting, by the information processing apparatus, information to indicate an operation to start browsing websites, as the information to indicate a start of use of digital content; and
acquiring, by the information processing apparatus, information to indicate a time of browsing of the user, as the information to indicate a period of use of digital content.

9. The information processing method according to claim 1, wherein the determining is include determining, by the information processing apparatus, that providing food and beverages to the user is necessary in a case where the period of use is longer than a threshold and the current time is outside a predetermined time period.

10. An information processing apparatus, comprising
a controller configured to:
detect information to indicate a start of use of digital content by a user;
acquire information to indicate a period of use of the digital content; and
determine a necessity of providing food and beverages to the user based on the information to indicate a period of use.

11. The information processing apparatus according to claim 10, wherein the controller is configured to notify the user information to indicate food and beverages that is enable to order in a case where it is determined that providing food and beverages to the user is necessary.

12. The information processing apparatus according to claim 10, wherein the controller is configured to order predetermined food and beverages in a case where it is determined that providing food and beverages to the user is necessary.

13. The information processing apparatus according to claim 10, wherein:
the controller is configured to notify the user information to indicate food and beverages that is enable to order in a case where it is determined that providing food and beverages to the user is necessary; and
the controller is configured to orders the food and beverages in a case where information to enable the order is received from the user.

14. The information processing apparatus according to claim 12, wherein the controller is configured to determine predetermined food and beverages based on the current time in a case where it is determined that providing food and beverages to the user is necessary.

15. The information processing apparatus according to claim 10, wherein:
the controller is configured to detect information to indicate an operation to start viewing a video, as the information to indicate a start of use of digital content; and
the controller is configured to acquire information to indicate reproduction time of the video, as the information to indicate a period of use of digital content.

16. The information processing apparatus according to claim 10, wherein:
the controller is configured to detect information to indicate an operation to start play of a video game, as the information to indicate a start of use of digital content; and
the controller is configured to acquire information to indicate a play time of the video game of the user, as the information to indicate a period of use of digital content.

17. The information processing apparatus according to claim 10, wherein:
the controller is configured to detect information to indicate an operation to start browsing of websites, as the information to indicate a start of use of digital content; and
the controller is configured to acquire information to indicate a time of browsing of the user, as the information to indicate a period of use of digital content.

18. The information processing apparatus according to claim 10, wherein the controller is configured to determine that providing food and beverages to the user is necessary in a case where the period of use is longer than a threshold and the current time is outside a predetermined time zone.

19. A non-transitory storage medium storing a program to cause a computer to execute:
detecting information to indicate a start of use of digital content by a user;
acquiring information to indicate a period of use of the digital content; and
determining a necessity of providing food and beverages to the user based on the information to indicate a period of use.

20. The non-transitory storage medium according to claim 19, wherein the program causes the computer to determine that providing food and beverages to the user is necessary in a case where the period of use is longer than a threshold and the current time is outside a predetermined time zone.
